(19) United States
(12) Patent Application Publication
(10) Pub. No.: US 2025/0168687 A1
(43) Pub. Date: May 22, 2025

(54) SYSTEMS AND METHODS FOR UE CAPABILITY REPORT

(71) Applicant: ZTE CORPORATION, Shenzhen (CN)

(72) Inventors: Nan ZHANG, Shenzhen (CN); Fangyu CUI, Shenzhen (CN); Jianwu DOU, Shenzhen (CN); Yachao YIN, Shenzhen (CN)

(73) Assignee: ZTE CORPORATION, Shenzhen (CN)

(21) Appl. No.: 19/035,637

(22) Filed: Jan. 23, 2025

Related U.S. Application Data
(63) Continuation of application No. PCT/CN2022/122984, filed on Sep. 30, 2022.

(51) Int. Cl. H04W 24/10; H04W 64/00

(52) U.S. Cl. CPC H04W 24/10; H04W 64/003

(57) ABSTRACT

Presented are systems and methods for user equipment (UE) capability report. A wireless communication device may report a first set of capability information associated with the wireless communication device to a wireless communication node.

### CROSS-REFERENCE TO RELATED APPLICATION

This application claims the benefit of priority under 35 U.S.C. § 120 as a continuation of PCT Patent Application No. PCT/CN2022/122984, filed on Sep. 20, 2022, the disclosure of which is incorporated herein by reference in its entirety.

### TECHNICAL FIELD

The disclosure relates generally to wireless communications, including but not limited to systems and methods for user equipment (UE) capability report.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication device (e.g., UE) may report/provide/inform/send a first set of capability information associated with the wireless communication device to a wireless communication node (e.g., gNB or base station (BS)).

In some implementations, the first set of capability information can include a plurality of subsets of capability information associated with the wireless communication device. Each of the plurality of subsets of capability information may correspond to a respective mode or location of the wireless communication device or traffic condition. In some arrangements, in response to determining that a current mode or location of the wireless communication device has changed, the wireless communication device may update/change/configure the first set of capability information to a second set of capability information.

In some arrangements, the first set of capability information and the second set of capability information may be overlapped. In some other arrangements, the first set of capability information and the second set of capability information may not be overlapped.

In some implementations, the wireless communication device can send/transmit/signal/provide assistance information to restrict capability of the wireless communication device to the wireless communication node. In some arrangements, the wireless communication device may send assistance information to report updated capability of the wireless communication device that is not included in the first set of capability information to the wireless communication node.

At least one aspect is directed to a system, method, apparatus, or a computer-readable medium. A wireless communication node may receive/obtain/acquire a first set of capability information associated with the wireless communication device from a wireless communication device.

The systems and methods presented herein include a novel approach for reporting UE capability. Specifically, the systems and methods presented herein discuss a novel solution for updating/changing/modifying the reported capability (e.g., first report) of the UE, and/or associating the UE with its capability according to one or more criteria (e.g., from a network).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example diagram of zones/regions corresponding to respective thresholds, in accordance with some embodiments of the present disclosure;

FIG. 4 illustrates an example flow diagram for updating UE capability, in accordance with some embodiments of the present disclosure; and

FIG. 5 illustrates a flow diagram of an example method for reporting UE capability, in accordance with an embodiment of the present disclosure.

### DETAILED DESCRIPTION

### 1. Mobile Communication Technology and Environment

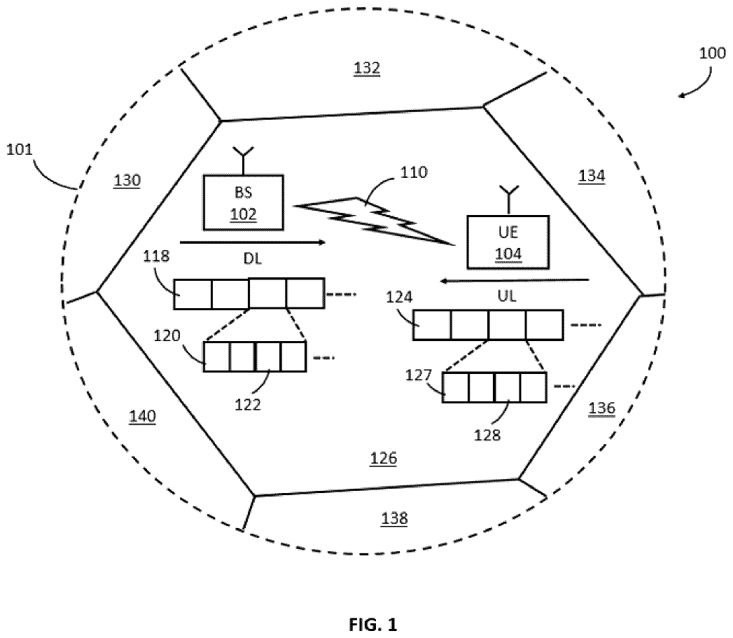

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

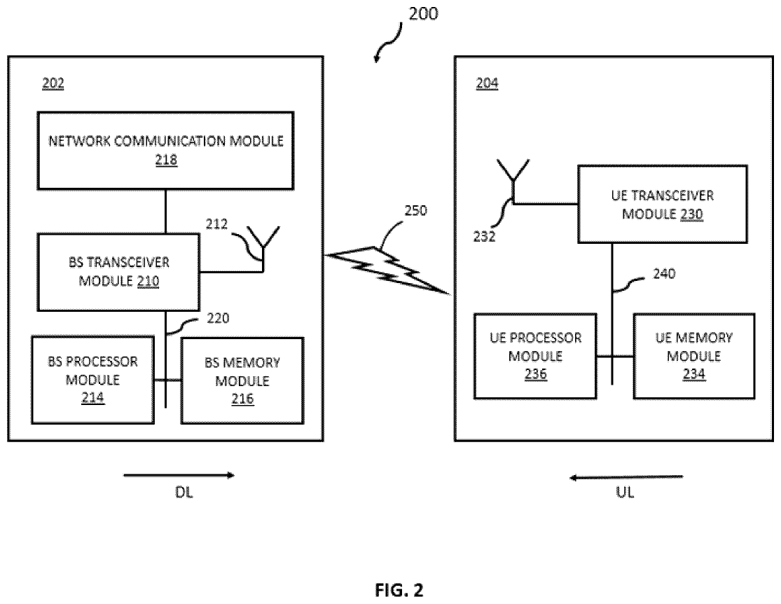

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (CNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for UE Capability Report

In certain systems (e.g., 5G new radio (NR), Next Generation (NG) systems, 3GPP systems, and/or other systems), the feature/capability of UEs 104 (e.g., UE capability) may be fixed in the communication once the UE capability has been reported and/or has accessed the network. In particular, after reporting the UE capability, it may be challenging to change such feature/capability information associated with the UEs 104. However, considering more diversification of at least one of terminal types, applications, traffic, scenarios, and/or different key performance indicators (KPIs), such as energy efficiency requirements and/or regulatory requirements, etc., it may be desired to update such information (e.g., the UE capability) within the communication. The systems and methods of the technical solution discussed herein can provide features, operations, and techniques that enable/support updating/changing/modifying of UE capability information within the communication after the feature/capability of the UE capability has been reported.

In various implementations, a mode of the UE 104 (e.g., UE mode) may refer to the RRC state of the UE 104 (e.g., RRC-connected, inactive, or idle) or motion state (e.g., hovering, flying, stop, stopping, accelerating, high-speed, descending, ascending, and/or stationary, etc.). The UE 104 can determine its mode, for example, according to whether the UE 104 is moving, such as based on readings/data from a motion sensor of the UE 104 or changes of in the height (e.g., via barometer). The location/position of the UE 104 may refer to cases where the UE 104 is at different altitudes/heights (e.g., absolute height or relative height compared to the ground-level or BS-level) and/or zone (e.g., in some regions/zones, the transmission power of an aerial UE may be restricted to fulfill the regulatory requirements/conditions/criteria), such as the disposition of the UE 104.

In some implementations, a traffic condition may refer to a type of traffic transmitted and/or received by the UE 104, e.g., ultra-reliable low latency communications (URLLC), among others. Different traffics can be indicated by corresponding indicators from at least one of the BS 102 and/or a higher layer of the UE 104. In some other implementations, the traffic condition may refer to a quality of service (QOS) requirement/condition for the information (e.g., expected) to be transmitted and/or received by the UE 104.

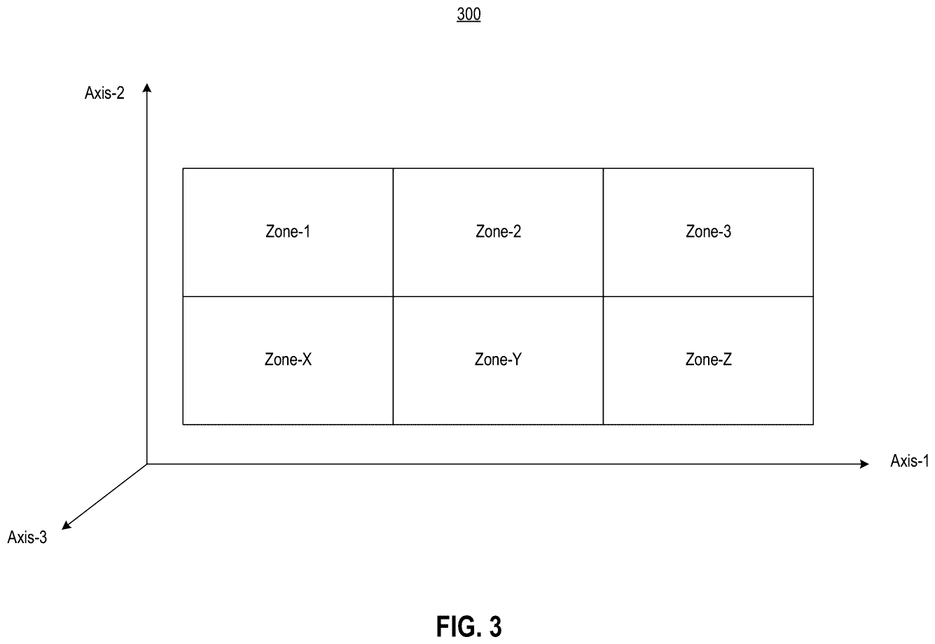

Referring to FIG. 3, depicted is an example diagram 300 of zones/regions corresponding to respective thresholds. As shown, the zone(s) may be defined or associated with corresponding thresholds (e.g., 2D or 3D). For instance, the thresholds may indicate location region(s), such as altitude/height, latitudinal and/or longitudinal boundaries/coordinates for the zones, and/or maximum transmission power (e.g., associated with specific location regions), among others. In this case, the UE 104 can determine its location based on whether the UE 104 is at, beyond, or within certain boundaries or thresholds. Hence, the UE 104 can associate its location to the corresponding zone based on the thresholds. The thresholds may be indicated/provided/configured by the network and/or regulatory requirement(s). The regulatory requirement may be configured for the BS 102, among other network devices. As discussed herein, the systems and methods of the technical solution can update/modify/change/configure the reported UE capability, such as responsive to changes to the mode and/or the location of the UE 104.

### EXAMPLE IMPLEMENTATION 1

The UE 104 (e.g., aerial UE, handset, and/or other terminals) can connect to the network for communication with one or more BS 102 (e.g., gNB). In response to connecting to the network, the UE 104 can report a first set of UE capabilities (e.g., first set of capability information), such as to at least one of the BS 102, among others.

In various arrangements, the UE 104 may report/provide the first set of capability information that includes various subsets of capabilities (e.g., multiple capability information) associated with the UE 104. Each of the subsets of capabilities may be associated with or correspond to different criteria/conditions/parameters, such as the respective mode of the UE 104, the respective location of the UE 104, and/or the respective traffic condition. For example, the subsets of capabilities may be in regard to or associated with at least one of a supported number of beams for transmission and/or reception (e.g., the number for reference signal (RS) for corresponding beam measurement), maximum transmission power (e.g., UE power class), and/or different values (e.g., assumed as different capabilities by the aerial UE in different locations), among other criteria. Each of the different values may be associated with respective zones, for example. For example, regarding the beam information, no-beamforming may be supported on ground-level (e.g., on-ground-level mode). In a flying mode, the UE 104 can consider or determine the a number of beams supported for transmission. In regards to the power class (e.g., maximum transmission power), the UE 104 may consider or determine a power class of 26 dBm on the ground level, and the power can be reduced to 23 dBm once the UE 104 is in flying mode. In some cases, the UE 104 can reduce the power from 23 dBm to 20 dBm subsequent to switching from the ground mode to a flying mode, for example.

In this case, the BS 102 can receive/obtain the subsets of capability information from the UE 104. The UE 104 can monitor or determine the changes in the mode and/or location of the UE 104 and/or traffic condition (e.g., URLLC service, enhanced mobile broadband (cMBB), and/or voice over IP (VOIP) service, etc.). In response to the determination, the UE 104 can update the capability information associated with the UE 104 based on the current mode, location, and/or traffic condition. For instance, the UE 104 can update/modify/change from a first set (or subset) of capability information to a second set (or subset) of capability information associated with the mode, location, and/or traffic condition determined by the UE 104.

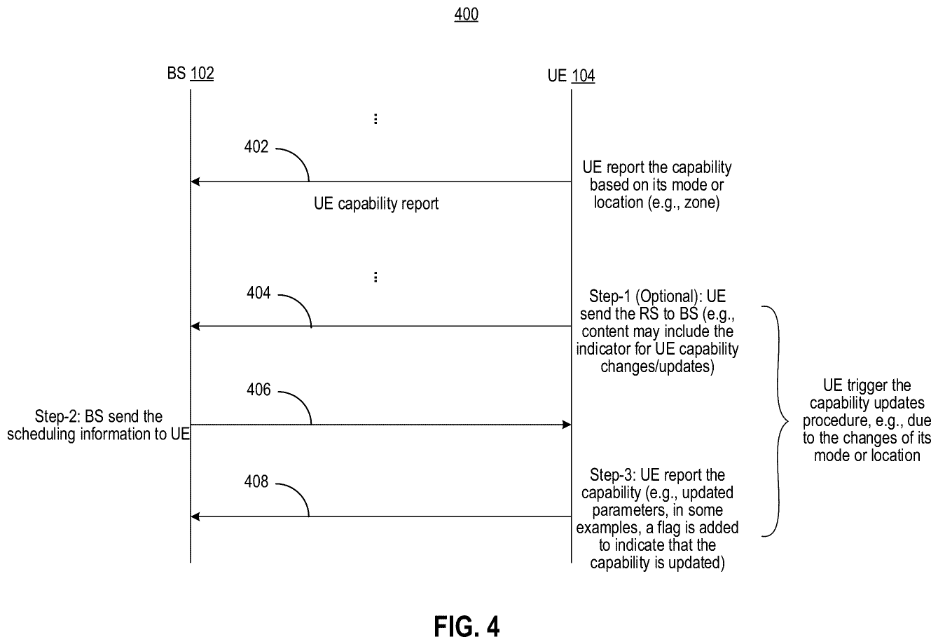

Referring to FIG. 4, depicted is an example flow diagram 400 for updating UE capability. In some arrangements, the UE 104 may report/signal/provide/transmit the UE capability (e.g., capability information) based on or associated with the current state of the UE 104, such as the current location (e.g., zone) and/or the mode of the UE 104 (402) and/or the traffic condition. For example, the UE 104 can determine its current situation/state (e.g., location, mode, and/or traffic condition) and associate the situation with the corresponding capability information. The UE 104 can determine the current situation based on the thresholds indicated by BS 102 or the regulatory requirement, for example.

Subsequent to providing the UE capability (e.g., the first set of capability information), the UE 104 can identify or determine that the situation (e.g., mode and/or location of the UE 104 and/or traffic condition) has changed or is relatively close to changing or about to change. For instance, the UE 104 can determine that the mode has changed (e.g., RRC state or motion state) and/or the the UE 104 is about to enter or entered a different zone (e.g., exceeds a threshold or boundary) to update the location with or without additional offset value, such as H>=Hₓ-h_offset. In this example, H can refer to the current height of the UE 104, H, can refer to the boundary of the region/zone associated with the reported first set of capability information, and h_offset can refer to the offset of the height and/or region.

In response to the change in the mode, the location, and/or the traffic condition, the UE 104 can trigger the reporting/updating of the UE capability in a second report, e.g., a second set of capability information of the UE 104. In some cases, the second set of capability information may include at least a portion of similar information (e.g., UE capabilities) as the first set of capability information (e.g., overlapping information). In some other cases, the second set of capability information may include one or more different/changed features/capabilities from the first set of capability information (e.g., non-overlapping information).

In some implementations, to trigger the capability update procedures (e.g., in response to changes in the mode and/or location of the UE 104 and/or the traffic condition), the UE 104 may send an RS to the BS 102 (404). The RS may include content having an indicator/signaling/identifier for the UE capability change/update. In some cases, the UE 104 may not transmit the RS to the BS 102. The BS 102 may send scheduling information to the UE 104 (406). The BS 102 can provide the scheduling information to provide resources to the UE 104 for reporting its capability, for example. Accordingly, in response to the changes in the situation, the UE 104 can report another set of capabilities (e.g., second set of capability information) to the BS 102 (408). The second set of capability information may include one or more updated/modified/changed parameters and/or one or more similar parameters compared to the first set of capability information. In certain aspects, the second report may include a flag indicating that the capability information of the UE 104 is updated.

### EXAMPLE IMPLEMENTATION 2

Similarly to the example implementation 1 discussed above, the UE 104 (e.g., aerial UE, handset, and/or other terminals) can connect to the network for communication with one or more BS 102 (e.g., gNB). In response to connecting to the network, the UE 104 can report a first set of UE capabilities (e.g., first set of capability information), such as to at least one of the BS 102, among others.

In some arrangements, based on the state/situation or changes of the state of the UE 104 (e.g., mode, location, and/or traffic condition), the UE 104 may send/transmit/assign (e.g., additional) information (e.g., sometimes referred to as assistance information) to the network (e.g., BS 102). The assistance information can provide/indicate one or more restrictions (e.g., reduction of UE capability on multiple-input/multiple-out (MIMO), power information, etc.) for communication between the UE 104 and the BS 102, among other devices. For instance, based on the state of the UE 104, the UE 104 can send the assistance information to restrict or apply at least one restriction on the UE capability (e.g., restriction on a portion of the first set of capability information), thereby reducing the capability of the UE 104. Reducing the capability of the UE 104 can improve the communication between the UE 104 and the BS 102, such as in lower bandwidth zones/regions (e.g., reducing MIMO), etc. In some cases, reducing the capability of the UE 104 can avoid interference by other communications, such as by reducing the number of beams and/or reducing the maximum transmission power.

In certain arrangements, the first set of capability information may include one or more predefined UE capabilities (e.g., basic parts of UE capabilities). The basic parts of UE capabilities may refer to capability information shared across different modes, locations, and/or traffic conditions, such that changes to the mode and/or location of the UE 104 and/or traffic condition may not change certain basic parts of the UE capabilities, for example. In response to the current state or changes of the state (e.g., mode, location, and/or traffic condition) of the UE 104, the UE 104 may send additional information (e.g., assistance information) to the BS 102 (e.g., network) to provide/send some add-on/additional feature/capability (e.g., support analog beam and/or QCL-Type-D, among other features not included) in the previously reported first set of UE capabilities. Additionally or alternatively to the add-on, the UE 104 can update/modify at least one previous value (e.g., update the supported power, modulation and coding scheme (MCS), and/or MIMO information) in the previously reported first set of UE capabilities for the communication between the UE 104 and the BS 102, among other devices of the network. Hence, the systems and methods of the technical solution can provide reporting and/or updating of UE capability information within the communication after an initial reporting of the UE capabilities.

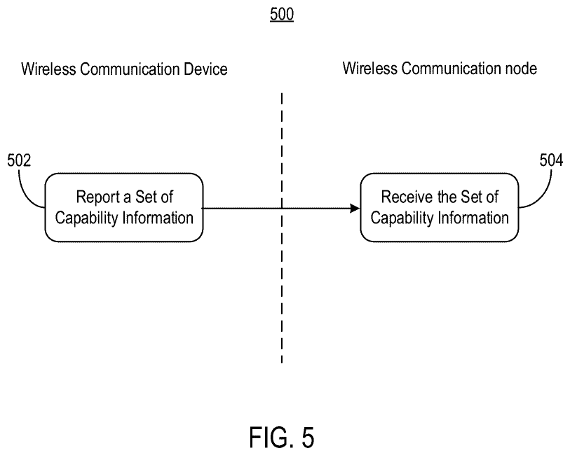

FIG. 5 illustrates a flow diagram of a method 500 for for reporting UE capability. The method 500 may be implemented using any of the components and devices detailed herein in conjunction with FIGS. 1-4. In overview, the method 500 may include reporting a set of capability information (502). The method 500 may include receiving the set of capability information (504).

In various arrangements, a wireless communication device (e.g., a UE) may report/send/transmit/provide/signal/indicate a first set of capability information (e.g., UE capabilities) to a wireless communication node (e.g., BS, gNB, or network node) (502). In response to the reporting, the wireless communication node can receive/obtain/acquire the first set of capability information from the wireless communication device. The first set of capability information can be associated with the wireless communication device. The wireless communication device may send the first set of capability information in response to a connection with the wireless communication node, among other network devices or nodes, for example.

In some arrangements, the first set of capability information can include various subsets of capability information associated with the wireless communication device. Each of the subsets of capability information can correspond to a respective mode and/or location of the wireless communication device and/or traffic condition. For instance, a first subset of capability information may correspond to a first mode and/or first location, a second subset of capability information may correspond to a second mode and/or second location (e.g., the second mode and/or the second location may be similar to or different from the first mode and/or the first location), and so forth. The first subset of capability information and the second subset of capability information may also be associated with similar or different traffic conditions.

In certain arrangements, in response to determining that a current mode and/or location of the wireless communication device (e.g., and/or in some cases, traffic condition) has changed or is relatively close to (e.g., about to) change, the wireless communication device can update/modify/change the first set of capability information to a second set of capability information.

In some implementations, the first set of capability information and the second set of capability information may be overlapped. For example, one or more capabilities of the first set of capability information may overlap or be the same as one or more capabilities of the second set of capability information.

In some implementations, the first set of capability information and the second set of capability information may not be overlapped. For example, at least one of the capabilities of the second set of capability information may be different from the capabilities of the first set of capability information.

In some arrangements, the wireless communication device may send assistance information (e.g., additional information) to the wireless communication node. The wireless communication device may send the assistance information to restrict the capability of the wireless communication device, such as based on at least one of the mode and/or location of the wireless communication device and/or the traffic condition. For instance, each mode, location, and/or traffic condition may be associated with respective capabilities. Certain modes, locations, and/or traffic conditions may be associated with reduced capabilities as compared to the first set of capability information, for example. In this case, the wireless communication can provide at least one restriction to the capability of the wireless communication device, such as indicated in the first set of capability information, to support the communication between the wireless communication device and the wireless communication node.

In certain arrangements, the wireless communication device may send assistance information to the wireless communication node to report updated capability of the wireless communication device that is not included in the first set of capability information. For example, to enhance the communication between the wireless communication device and the wireless communication node based on the mode, location, and/or traffic condition, the wireless communication device can transmit additional information (e.g., add-on features/capabilities/supports) and/or update certain value(s) in the first set of capability information. The values may include supported power, MCS, and/or MIMO information, among others.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method, comprising:
reporting, by a wireless communication device to a wireless communication node, a first set of capability information associated with the wireless communication device.

2. The wireless communication method of claim 1, wherein the first set of capability information includes a plurality of subsets of capability information associated with the wireless communication device, and wherein each of the plurality of subsets of capability information corresponds to a respective mode or location of the wireless communication device or traffic condition.

3. The wireless communication method of claim 2, further comprising:
in response to determining that a current mode or location of the wireless communication device has changed, updating, by the wireless communication device, the first set of capability information to a second set of capability information.

4. The wireless communication method of claim 3, wherein the first set of capability information and the second set of capability information are overlapped.

5. The wireless communication method of claim 3, wherein the first set of capability information and the second set of capability information are not overlapped.

6. The wireless communication method of claim 1, further comprising:
sending, by the wireless communication device to the wireless communication node, assistance information to restrict capability of the wireless communication device.

7. The wireless communication method of claim 1, further comprising:
sending, by the wireless communication device to the wireless communication node, assistance information to report updated capability of the wireless communication device that is not included in the first set of capability information.

8. A wireless communication method, comprising:
receiving, by a wireless communication node from a wireless communication device, a first set of capability information associated with the wireless communication device.

9. The wireless communication method of claim 8, wherein the first set of capability information includes a plurality of subsets of capability information associated with the wireless communication device, and wherein each of the plurality of subsets of capability information corresponds to a respective mode or location of the wireless communication device or traffic condition.

10. The wireless communication method of claim 9, wherein in response to determining that a current mode or location of the wireless communication device has changed, the first set of capability information is updated to a second set of capability information.

11. The wireless communication method of claim 10, wherein the first set of capability information and the second set of capability information are overlapped.

12. The wireless communication method of claim 10, wherein the first set of capability information and the second set of capability information are not overlapped.

13. A wireless communication node, comprising:
at least one processor configured to:
receive, via a receiver from a wireless communication device, a first set of capability information associated with the wireless communication device.

14. A wireless communication device, comprising:
at least one processor configured to:
report, via a transmitter to a wireless communication node, a first set of capability information associated with the wireless communication device.

15. The wireless communication method of claim 14, wherein the first set of capability information includes a plurality of subsets of capability information associated with the wireless communication device, and wherein each of the plurality of subsets of capability information corresponds to a respective mode or location of the wireless communication device or traffic condition.

16. The wireless communication method of claim 15, wherein the at least one processor is configured to:
in response to determining that a current mode or location of the wireless communication device has changed, update the first set of capability information to a second set of capability information.

17. The wireless communication method of claim 16, wherein the first set of capability information and the second set of capability information are overlapped.

18. The wireless communication method of claim 16, wherein the first set of capability information and the second set of capability information are not overlapped.

19. The wireless communication method of claim 14, wherein the at least one processor is configured to:
send, via the transmitter to the wireless communication node, assistance information to restrict capability of the wireless communication device.

20. The wireless communication method of claim 14, wherein the at least one processor is configured to:
send, via the transmitter to the wireless communication node, assistance information to report updated capability of the wireless communication device that is not included in the first set of capability information.
